(19) United States
(12) Patent Application Publication
(10) Pub. No.: US 2005/0030160 A1
(43) Pub. Date: Feb. 10, 2005

(54) Multimode wireless local area network/radio frequency identification asset tag

(76) Inventors: David P. Goren, Smithtown, NY (US); Raj Bridgelall, Mount Sinai, NY (US); Bruce A. Willins, East Northport, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/827,935

(22) Filed: Apr. 19, 2004

Related U.S. Application Data
(60) Provisional application No. 60/463,715, filed on Apr. 17, 2003.

(51) Int. Cl. H04Q 5/22

(52) U.S. Cl. 340/10.5; 702/40

(57) ABSTRACT

Asset tags for use in a WLAN/RFID system are provided. The asset tag comprises a processor, an RFID antenna coupled to the processor and configured to receive interrogations from an RFID reader and send replies to the RFID reader; and a wireless transceiver coupled to the processor, the wireless transceiver configured to receive information from and send information to a wireless access port of a wireless local area network.

### CROSS-REFERENCE TO RELATED APPLICATIONS

This application claims the benefit of provisional application No. 60/463,715, filed on Apr. 17, 2003.

### TECHNICAL FIELD

This invention relates to the field of radio frequency identification and, more specifically, to a multimode wireless local area network/radio frequency identification asset tag.

### BACKGROUND

In today's marketplace, the ability to provide efficient services on a slim profit margin is vitally important. A large cost to consumer retail stores and other businesses that handle a large inventory is the tracking of the individual items of inventory as they move through the supply chain.

One popular method for tracking inventory involves the use of barcodes. In a barcode tracking system, products are labeled with a barcode. The configuration of the barcode encodes information, such as a product identification number or similar information. Then, when needed, the barcode is read using a barcode reader. While this works as an acceptable tracking system in some cases, barcodes have several drawbacks. First, barcodes are limited in the amount of information they can encode. Also, once a barcode is printed it is impossible to change information represented by the barcode without generating a new barcode and placing the new barcode on the tracked asset. Additionally, a barcode must be in the line of sight of the barcode reader to be read.

To alleviate some of the drawbacks of barcode systems, various Radio Frequency Identification (RFID) systems have been proposed. In a typical embodiment, RFID systems comprise at least one RFID reader and at least one RFID tag. The RFID tags are attached to items of interest to be tracked. RFID tags typically fall into one of three types; active RFID tags, passive RFID tags, and semi-passive RFID tags.

Active RFID tags include an internal power source, typically a battery, to continuously power the RFID tag, including RF communication circuitry. Active RFID tags can receive very low-level RF signals and can generate high-level signals because the RFID circuitry is powered by a battery. RFID tags are typically used when a long tag read distance is needed. A drawback of active RFID tags is that the battery, and therefore the RFID tag, has a finite life.

Passive RFID tags utilize the RF energy sent by the RFID reader to power the passive RFID tag. Passive RFID tags store energy from the RFID reader's interrogation signal, and, when sufficient energy is available to power the passive RFID tag, a reply is set from the passive RFID tag to the RFID reader. Because the passive RID tag does not have its own on board power source, the return signal from the passive RFID tag is typically a very low level signal. Passive RFID tags are usually used in cases when the RFID reader and RFID tag will be in close proximity.

Semi-passive RFID tags include an internal power supply to power a volatile or onboard sensor used to monitor external environmental conditions. Semi-passive RFID tags still requires energy transitioned from the reader to power the response, similar to passive RFID tags. Active RFID tags have a longer range than passive tags which typically must be near the RFID reader in order to receive the signal to power the tag. Active RFID tags, because they require a source of power, are more difficult to maintain, as the batteries need to be periodically replaced.

RFID tags are read using an RFID reader. In a typical embodiment, the RFID reader emits a RF signal in the direction of one or more tags. The emitted RF signal is known as an interrogation. The interrogation is received by one or more RFID tags. The signal can include data that allows different tags to determine if the tag should respond to the interrogation. If a given tag does need to respond, it responds, in one embodiment, by using a backscattered signal. One advantage of an RFID system over other inventory tracking systems is that RFID tags can contain non-volatile memory that can be reprogrammed using an RFID reader. Also, the non-volatile memory of an RFID tag can store more data then a barcode. Additionally, RFID readers do not need to be in the line of sight of the RFID tags in order to read a RFID tag.

Not only is it desirable to determine information about an item by reading its RFID tag, it is also desirable to track inventory in real time as the inventory moves through an area such as in a warehouse. There are known methods that can track wireless devices within a wireless network. These are known as real time location systems (RTLS) and include measuring signal strength, utilizing time difference of arrival, angle of arrival or other techniques. Therefore, it is desirable to provide a multimode WLAN/RFID asset tag that allows for real time location.

### BRIEF SUMMARY

In accordance with the teachings of the present invention, there is provided an asset tag for use in a WLAN/RFID system. The asset tag comprises a processor, an RFID antenna coupled to the processor and configured to receive interrogations from an RFID reader and send replies to the RFID reader; and a wireless transceiver coupled to the processor, the wireless transceiver configured to receive information from and send information to a wireless access port of a wireless local area network.

In an embodiment of the present invention, the asset tag, after a set time has elapsed, can go into an idle state. The tag can transition out of the idle state after the receipt of a wakeup signal. The signal, in one embodiment, can be provided by a paging system signal sent over the wireless local area network. In another embodiment, the wakeup signal is provided by an RFID reader.

In accordance with the teachings of the present invention an asset tag for a WLAN/RFID system is disclosed. The asset tag comprises a processor, an RFID antenna coupled to the processor and configured to receive interrogations from an RFID reader and send replies to the RFID reader; and a wireless transceiver coupled to the processor, the wireless transceiver configured to receive information from and send information to a wireless access port of a wireless local area network. Further, the tag is configured to emulate an active tag, a passive tag or a semi-active tag.

In accordance with the teachings of the present invention, there is provided a system for tracking an asset within a wireless local area network. The system comprises a plurality of wireless access points coupled to at least one server computer and a tag attached to the asset. The tag comprising a wireless transceiver configured to send a tracking signal to the plurality of wireless access points. The wireless access points receive the tracking signals from the tag; communicate the tracking signal to the server computer and the server computer processes the tracking signals to determine a location of the asset.

### BRIEF DESCRIPTION OF THE DRAWINGS

The present invention will hereinafter be described in conjunction with the following drawing figures, wherein like numerals denote like elements, and

FIG. 1 illustrates the present invention in an exemplary deployment;

FIG. 2 illustrates the present invention in a second exemplary deployment;

FIG. 3 is a block diagram of the present invention; and

FIG. 4 is a block diagram of an alternative embodiment of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The present invention, in one exemplary embodiment, discloses a multimode WLAN/RFID tag. The multimode tag can be attached to an item to be tracked. The tag can be used like a conventional RFID tag. The RFID tag can receive interrogations from an RFID reader and reply to the interrogations. If the RFID tag includes read/write memory, the RFID reader can also write information to the RFID tag. In the present invention, a wireless transceiver is integrated with a standard RFID tag. The wireless transceiver in the multimode tag communicates with a wireless area network (WLAN) access point. The WLAN access point is coupled to a network that includes one or more server computers. The WLAN access point can read information from the tag and store information to the tag in a similar fashion as the RFID reader. This is because, in part, the memory is either shared between the RFID functionality and the wireless functionality or the RFID functionality and the wireless functionality can share data stored in different memories. Additionally, providing a wireless receiver in a multimode tag allows for known location techniques to be used to provide for real time location of a tagged item.

The present invention also provides a multimode tag that can emulate either an active tag, a passive tag or a semi-passive tag. The particular emulation can be selected by a user and sent as a command to set the emulation via the wireless access point. Alternatively, the emulation mode can be based on the state of the battery charge. The emulation mode can also be set automatically by the processor, based on the state of the multimode tag.

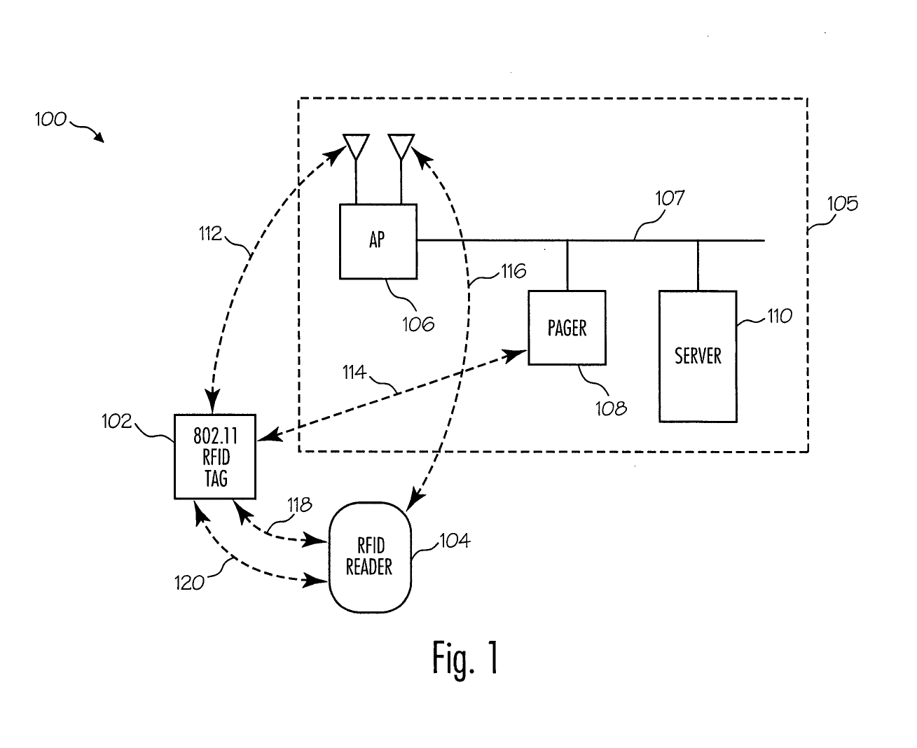

An exemplary system 100 showing the use of the present invention is illustrated in FIGS. 1-3. In exemplary system 100, one or more multimode tags 102 are attachable to assets (not shown), such as individual boxes, or collections of assets (not shown) such as a pallet of boxes. The system 100 further comprises a wireless local area network 105 comprising one or more wireless access points 106 coupled to one or more server computers 110 via a network connection 107. The system 100 may also include one or more RFID readers 104.

Multimode tag 102 can attach to an asset and store information concerning the asset. The information can be read from the tag using the RFID reader 104. Additionally, in accordance with the teaching of the present invention, the information can be sent from the tag 102 to the wireless access point 106 via a wireless link 112. The wireless access point 106 can then route the information to a computer network such as server computer 110. In one embodiment, information can be written to the multimode tag 102 either using RFID reader 104 or wireless access point 106.

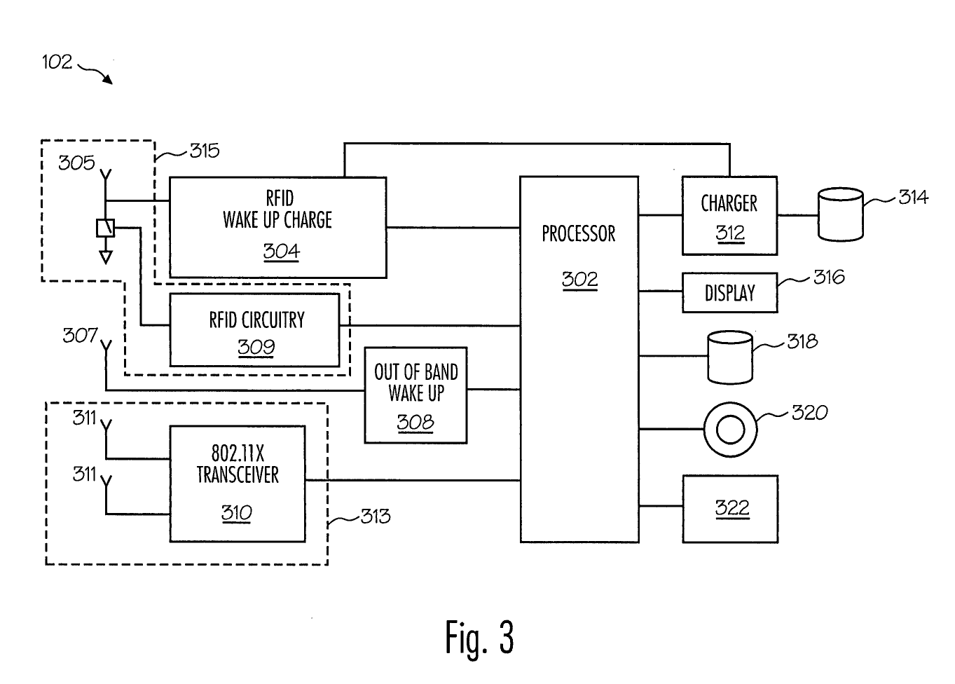

In an exemplary embodiment of the present invention, and with reference to FIG. 3, multimode tag 102 comprises a processor 302 coupled to a wireless communication portion 313 comprising a wireless transceiver 310 and a wireless antenna 311 for communicating with a wireless access point 106 and a RFID communication portion 315 comprising a RFID tag circuit 309 and a RFID antenna 305 for communicating with a RFID reader 104. Multimode tag 102 further comprises a wireless wakeup circuit 308 coupled to the processor 302 and an RFID wakeup/charge circuit 304. Either the wireless wakeup circuit 308 or the RFID wakeup/charge circuit 304 can be used to “wakeup” the multimode tag 102 from an idle state which will be discussed in further detail below. RFID wakeup/charge circuit 304 is also coupled to a charge circuit 312 which charges a battery 314. Multimode tag 102 may also include output devices such as a display 316, and audible output 320. Multimode tag 102 may also include input devices such as sensors 318. Multimode tag 102 further includes a memory 322.

Processor 302 is any processor capable of receiving and manipulating data. For example, processor 302 handles the storage and retrieval of data from memory 322. Processor 302, in one embodiment, can include a timer routine that puts the multimode tag 102 in an “idle” state after a certain time has lapsed. In an idle state, the wireless transceiver 310 is inactive, saving battery life. As is known in the art, timer routines may be implemented in software, in hardware or in a combination of software and hardware. Processor 302 can be any commonly available processor, such as those manufactured by Microchip, of Chandler Ariz.

In another embodiment, processor 302 may include a tag emulation selection routine that allows the processor to switch the type of tag that multimode tag 102 will emulate (active, semi-passive or passive). In one embodiment, the processor can monitor battery charge. If the battery has enough charge to support an active tag emulation, multimode tag will emulate an active tag. If the battery charge drops below the level that supports an active tag emulation, a semi-passive emulation can be set. If the battery drops below the level that supports a semi-active tag, a passive tag emulation can be set.

In an alternative embodiment, the multimode tag can switch between tag emulation based on commands received by the multimode tag 102 sent from, for example, server computer 110 via wireless access point 106. For example, a command can be sent to place the multimode tag 102 into a passive emulation to conserve battery charge. Subsequently, a command to place the multimode tag 102 into an active tag emulation can be received when it is necessary to locate a tag using a remote reader.

In yet another alternative, the processor 302 may automatically place the multimode tag in to a specific emulation based on the occurrence of an event. For example, every time the processor places the multimode tag into an idle state, it could set multimode tag 102 to be in a passive tag emulation. When the tag wakes up from an idle state, the processor can place the multimode tag 102 into an active tag emulation. Also, any combination of the above methods or any other methods can be used to change the emulation of the multimode tag 102.

Wireless transceiver 310, in conjunction with one or more wireless LAN antennas 311, is any device capable of communicating wirelessly with other wireless devices. Wireless transceiver 310 may receive data from and transmit data to other wireless devices such as wireless access point 106. Wireless transceiver 310 can be compliant with wireless standards such as IEEE standards 802.11a, 802.11b and 802.11g, although the present invention can utilize any wireless protocol. WLAN transceivers 310 are known in the art and commercially available.

RFID tag antenna 305 receives RFID signals sent by RFID reader 104 and sends replies to RFID reader 104. The design of RFID tag antenna 305 is known in the art. RFID tag circuitry 309 can be any circuitry that, in conjunction with RFID antenna 305, is necessary for the reception of RFID reader interrogations and for the transmission (or emissions) of replies to those interrogations. RFID tag circuitry 309 can include storage capacitors for storing energy received by the RFID reader if the RFID circuitry is not powered by the battery 314 or is powered by both an internal storage capacitor and battery 314. Also, RFID tag circuitry 309 can include internal logic and memory, as needed. The design and implementation of RFID tag circuitry is known in the art and RFID tag circuitry is available commercially. When the RFID tag antenna 305 is said to receive an interrogation from the RFID reader 104, that reception includes the reception of the signal by any circuit or structure needed for the use of the RFID tag transmissions, including circuitry included in RFID tag circuitry 309.

Wakeup/charge circuit 304 provides energy to charging circuit 312 to charge the battery 314 to provide power to the multimode tag 102. In one embodiment, when the RFID reader 104 and the multimode tag 102 are in proximity to each other, the RFID tag antenna 305 inductively couples with the antenna of the RFID reader 104 when the RFID reader 104 is sending a RF signal, inducing a voltage in the RFID tag antenna 305 that is rectified and regulated by wakeup/charge circuit 304. The rectified voltage is supplied to the charging circuit 312 for charging the battery 314. Also, in one embodiment of the present invention where the multimode tag 102 is in an idle state, receiving the induced voltage at the wakeup/charge circuit 304 can cause a signal to be generated that “wakes” the multimode tag 102 from the idle state.

Charge circuit 312, as discussed previously, charges the battery 314. Charging circuit 312 can operate under control of processor 302 or independent of the processor 302. The design of charging circuit 312 can vary depending on the battery type being charged. The various designs of charging circuits are well known to those of skill in the art.

Output devices such as display 316 and audible output 320 provide visual and aural feedback to the user. Input devices, such as sensor 318, provide data to the multimode tag 102 regarding conditions exterior to multimode tag 102. For example, sensor 318, in one embodiment, is a motion sensor. If the multimode tag 102 is in an idle state, movement of the tag can trigger the motion sensor, transitioning the multimode tag 102 to an active state. Sensor 318 can also be an acoustic sensor. An acoustic sensor can be set to be sensitive to a certain sound level, pattern or signature. Once that sound level, pattern or signature is reached, the sensor 318 can trigger multimode tag 102 to enter an active state. Using acoustic sensor 318 to activate multimode tag 102 can be advantageous in situations when the multimode tag 102 is placed in an area where electromagnetic energy, such as from an RF reader, penetrates poorly, such as next to metal or water. When the multimode tag 102 is near metal or liquids, a certain acoustical sound level or pattern or signature could be used to trigger the multimode tag 102, when a RF signal could not. Once awakened, the multimode tag 102 could then communicate using the wireless communication portion 313 or via the RFID communication portion 315 especially if the multimode tag 102 is in an active mode. Other sensors, such as moisture, temperature and the like can be used as sensor 318, to measure external conditions and trigger an action by the multimode tag 102.

Wireless wakeup circuit 308, upon receipt of a specific wireless signal, will signal processor 302 to activate multimode tag 102. Activation of multimode tag 102, in the context of the present invention, includes activation of the wireless transceiver 310.

Memory 322 is typically a non-volatile memory that provides storage for data without the need for battery backup, however, memory 322 can be any memory or memory subsystem adaptable for storing data such as solid state memory including any collection or combination of read-write volatile memory, read only non-volatile, read/write non-volatile (including but not limited to flash memory, EEPROM, ferroelectric random access memory, and/or magnetoresistive ram, or magnetic ram). Additionally, the present invention could also utilize memory such as magnetic storage devices, optical storage devices and the like. Memory 322 is accessible by both the RFID communication portion 315 of multimode tag 102 and the wireless communication portion 313 of multimode tag 102. Thus, data can be retrieved either via an RFID interrogation or a request from a WLAN (as received by the wireless transceiver 310). Memory 322 can be read only; write once, read many; or read/write memory. Since the memory 322 is a shared memory, in this embodiment, if memory 322 can be written to, the memory can be written to using either an RFID reader 104 or by a wireless LAN.

Referring back to FIG. 1, wireless access point 106 communicates with multimode tag 102. In one embodiment, wireless access point 106 communicates using a wireless local area protocol such as the ones specified in IEEE standards 802.11; however, any wireless protocol can also be used. Wireless access point 106 also provides a wired or wireless interface to a computer network, the computer network containing one or more computer servers 110. The wireless access point 106 and server computer 110 can be connected by connection 107, which can be a wireless or wired connection.

Server computer 110 receives data from and sends data to the wireless access point 106. Server computer 110 can store and/or process the received data. In one embodiment, server computer 110 can execute a real time location system program as will be discussed in greater detail below. Sever computer 110, while shown as a single server computer in FIG. 1 can be one or more coupled computers. Server computer 110 can be any computer capable of being connected to a network including server computers commercially available from Dell Computers, of Houston Tex.

The exemplary system 100, in accordance with the teachings of the present invention, may also include a paging unit 108. Paging unit 108 transmits a signal, that, when received by multimode tag 102, can transition multimode tag 102 from an idle state to an “awake” state or active state. In one embodiment, the frequency of the paging signal is set to be outside of the band of frequency used by wireless access point 106 to avoid interference with the wireless access point 106. Paging unit 108 can be a wide area system that sends its paging signal over a large area or paging unit 108 may send a page only in a small confined area. Paging units are well known in the art and can be provided as part of server computer 110 or as a separate unit. The frequency transmitted by the paging unit 108 can be adjustable. In a group of tags, several different wakeup frequencies can exist. Thus, specific groups of tags can be activated while others stay in the idle condition.

RFID reader 104 requests and receives information from multimode tag 102. In a typical embodiment, the RFID reader 104 sends a request (an “interrogation”) to a multimode tag 102 to read the multimode tag 102. The multimode tag 102 receives the interrogation and responds, in a typical environment, by backscattering the received signal to the RFID reader 104. Additionally, if the multimode tag 102 includes read/write memory, the RFID reader can be used to write information to multimode tag 102.

Additionally, the transmission of a signal from RFID reader 104 can both awaken an idle tag and provide a charging voltage to the tag using well known techniques such as inductive coupling, as discussed previously.

In use, multimode tag 102 is affixed to an asset. The multimode tag 102 allows tracking of the asset through the supply chain and provides information concerning the assets. Multimode tag 102 can also be used to perform real time location (RTLS) of an asset.

An advantage of the multimode tag 102 of the present invention is that it can communicate through the wireless local area network 105. This communication can be for several reasons. First, a wakeup signal can be sent through the wireless access point 106. This will cause the multimode tag 102 to transition from an idle state to an active state. By allowing the multimode tag 102 to go to an idle state and awaken from that idle state, power on board the multimode tag 102 can be conserved. For example, in the idle state the power to the wireless transceiver 310 can be turned off to conserve power. Also, multimode tag 102 can be in full two way communication with the wireless local area network 105. Full two way communication allows a computer on the network, such as server computer 110, to request and retrieve information from the multimode tag 102. Also, if the multimode tag 102 has read/write memory, the multimode tag 102 can have new information sent via the wireless local area network 105 and written to the memory of the multimode tag 102, this allowing many tags to be updated at once using the wireless local area network 105, as opposed to being reprogrammed one tag at a time by a RFID reader.

The multimode tag 102 of the present invention, when operating within a wireless local area network 105, can be used as part of a real time location system (RTLS) to track the location of a moving (or stationary) asset. RTLS in the wireless local area network 105 can be implemented as a passive system or an active system. In a passive system, the wireless access points 106 listen for transmissions of a tracking signal from the wireless transceiver 310 of the multimode tag. The tracking signals can be special signals sent by the multimode tag 102 that are intended to be used for tracking purposes, or the tracking signals can be any signal sent from the multimode tag 102. The periodic tracking signals are received by, in a typical embodiment, at least three wireless access points 106 of the wireless local area network 105. The asset with the attached multimode tag 102 can then be located using triangulation. Techniques such as measuring the signal strength of the tracking signal at different access points, determining the angle of arrival of the tracking signal at different access points and measuring the time difference of arrival at different access points can be used in a passive system to track the multimode tag. In one embodiment, server computer 110 receives the tracking signal information and determines the location of the asset associated with the tag 102.

In an active system, the wireless transceiver 310 of the multimode tag 102 plays a more active role in the tracking process. One active tracking method is the use of ranging. In a ranging system, the distance between the wireless transceiver 310 of the multimode tag 102 and the fixed wireless access points 106 can be calculated by measuring the amount of time it takes for a signal to be sent from the wireless transceiver 310 of the multimode tag 102 to a plurality of wireless access points 106. In one embodiment, server computer 110 receives the tracking signal information and determines the location of the asset associated with the multimode tag 102. In another active tracking method, multimode tag 102 can receive signals from multiple access points 106 located in different areas. The multimode tag 102 can receive the signals and calculate a relative signal strength for each received signal. The signal strength measurements can then be sent to a server computer for the determination of the location of the tag based on signal strength.

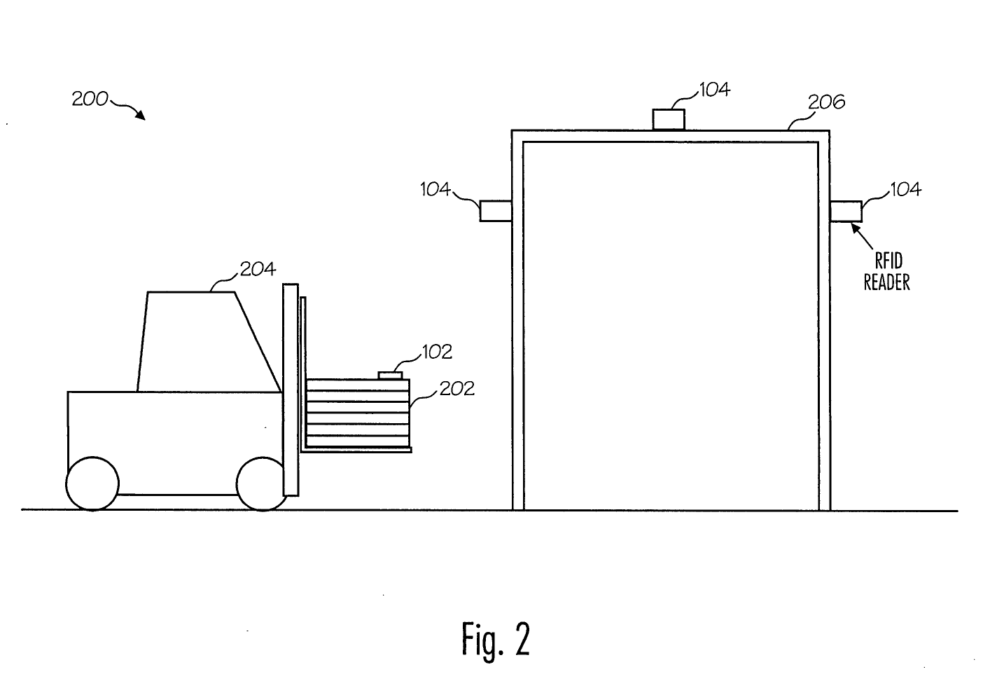

The multimode tag 102 in accordance with the teachings of the present invention can also be used with RFID reader 104 in a conventional manner. As discussed previously, RFID reader 104 can interrogate multimode tag 102 and receive replies from multimode tag 102. In embodiments where multimode tag 102 is a passive or semi-passive tag, RFID reader 104 can supply power to the RFID tag through inductive coupling. As discussed in conjunction with FIG. 2, the inductive coupling can be used to charge an onboard battery.

Fixed RFID readers 104 can also be used to locate tagged assets as part of a real time location system (RTLS). Fixed RFID readers 104 can locate tagged assets with high accuracy utilizing phase difference of arrival techniques. Such a location scheme is disclosed in U.S. patent application Ser. No. ______, entitled “Object Location System and Method Using REFID”, by Raj Bridgelall and assigned to Symbol technologies. This patent application is hereby incorporated by reference. A fixed RFID reader 104 is either physically affixed to a location or is a mobile RFID reader at a known location.

Another use of system 100 is illustrated in FIG. 2. As seen in FIG. 2, the present invention can be used to determine when an asset moves through a portal, such as a portal 206 in a loading dock. As seen in FIG. 2, an inventory transfer device 204 (in this example, a forklift) containing an asset 202 with multimode tag 102 attached moves through the portal 206, which has one or more RFID readers 104 affixed around or on the portal 206. In this embodiment, if multimode tag 102 is in an idle state, passing the asset 202 with the multimode tag 102 through a portal 206 can awaken the multimode tag 102. Also, when passing through the portal 206, data from the multimode tag 102 can be retrieved by using the RFID readers 104 to interrogate the multimode tag 102.

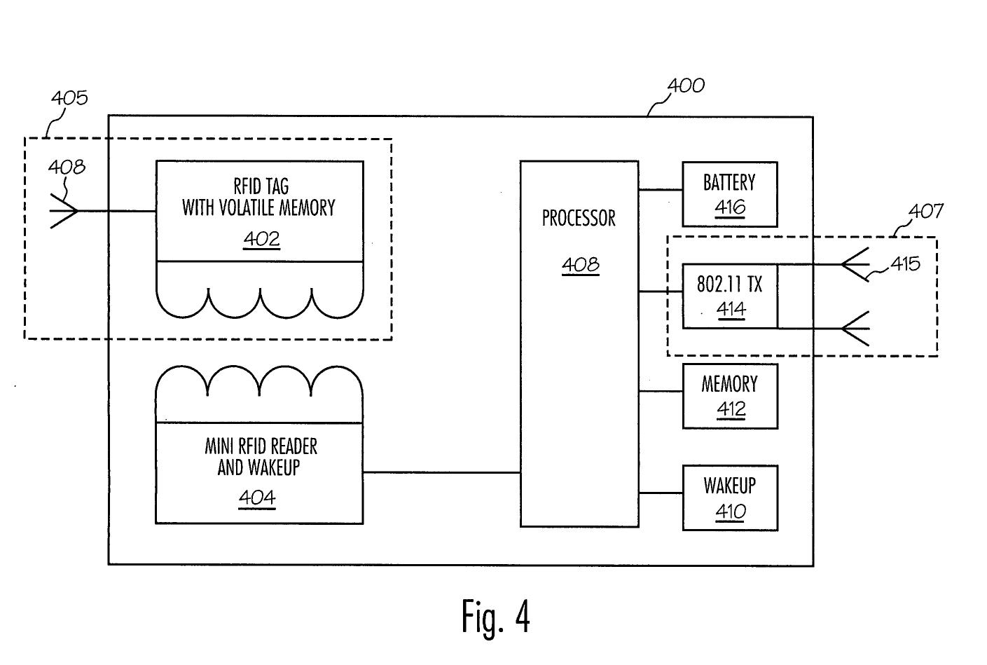

As discussed previously, multimode tag 102 includes a memory that was shared by both the RFID portion and the wireless portion of the multimode tag 102. In an alternative embodiment, as illustrated in FIG. 4, the multimode tag 400 has a separate memory for the a RFID communication portion 405 of the multimode tag 400 and a separate memory for the a wireless communication portion 407 of the multimode tag 400. However, data can be shared between the RFID communication portion 405 and the wireless communication portion 407. As seen in FIG. 4, multimode tag 400 comprises RFID communication section 405 comprising a conventional RFID tag 402 coupled to RFID antenna 403 and a wireless communication section 407 comprising a wireless transceiver 414 coupled to a wireless antenna 415. Multimode tag 400 further comprises a processor 408 coupled to, in one embodiment, a battery 416, a memory 412, an internal RFID reader 404 and a wakeup circuit 410.

RFID tag 402 can be any RFID tag circuitry that not only can be interrogated via RFID antenna 403, but also an internal RFID reader 404. RFID tag 402 may include memory (not shown), which is preferably non-volatile memory. RFID circuitry is well known in the art and commercially available.

Internal RFID reader 404 provides power to RFID tag 402 via inductive coupling or similar well known energy transmission methods used for passive RFID tags and sends interrogations to RFID tag 402 in order to receive a response from the RFID tag 402. Since RFID reader 404 is placed in close proximity to RFID tag 402, the output of the RFID reader 404 can be a low power output. In one embodiment, RFID reader 404 utilizes a low frequency signal to provide power to the RFID tag 402 and interrogate the RFID tag 402.

Processor 408 can be any processor as discussed previously. For example, processor 408 can be any processor capable of receiving and manipulating data. For example, processor 408 handles the storage and retrieval of data from memory 412. As is known in the art, timer routines may be implemented in software, in hardware or in a combination of software and hardware. Processor 408, in one embodiment, can include a timer routine that puts the multimode tag 400 in an “idle” state after a certain time has lapsed. In an idle state, the wireless transceiver 414 is inactive, saving battery life. Processor 408 can implement those timing routines for use in determining when to place tag 400 in an idle state. Processor 408 can also implement a tag emulation program as discussed previously. Processor 408 can be any commonly available processor, such as those manufactured by Microchip, of Chandler Ariz.

Battery 416 can be any battery that can power the components of multimode tag 400 and fit in the size constraints of the multimode tag 400. In a typical embodiment, battery 416 is not rechargeable. In a typical embodiment, battery 416 does not provide power to the RFID tag 402 portion of the multimode tag 400. In this embodiment, the RFID portion of multimode tag 400 will act as a passive tag only.

Memory 412 can be either volatile or non-volatile memory. Memory 412 be any memory or memory subsystem adaptable for storing data such as solid state memory including any collection or combination of read-write volatile memory, read only non-volatile, read/write non-volatile (including but not limited to flash memory, EEPROM, ferroelectric random access memory (FRAM), and/or magnetoresistive ram, or magnetic ram (MRAM)). Additionally, the present invention could also utilize memory such as magnetic storage devices, optical storage devices and the like.

Wireless transceiver 414, like the wireless transceiver discussed in conjunction with FIG. 3, in conjunction with one or more wireless LAN antennas 415, can be any device capable of communicating wirelessly with other wireless devices. Wireless transceiver 414 can receive data from and transmit data to other wireless devices such as wireless access point 106. Wireless transceiver 414 can be compliant with wireless standards such as IEEE standards 802.11a, 802.11b and 802.11g, although the present invention can utilize any wireless protocol. Wireless transceivers 414 are known in the art and commercially available.

Wakeup circuit 410, like the wakeup circuit discussed in conjunction with FIG. 3, can be any circuit or device that, upon receipt of a specific wireless signal, can signal processor 408 to activate multimode tag 400. Activation of multimode tag 400, in the context of the present invention, includes activation of the wireless transceiver 414.

In this embodiment, the RFID communication section 405 of the tag 400 and the wireless communication section 407 of the tag do not share the same memory; each has its own memory. However, data can be shared. Data from memory 412 or received via wireless transceiver 414 can be stored to the memory of the RFID tag 402 by writing the data to the RFID memory using the RFID reader 404. Of course, the RFID memory needs to be a writeable memory. One use for this is to store the contents of memory 412 to the RFID memory when the battery was nearly discharged and unable to maintain memory 412 (in this example memory 412 would be volatile memory). Additionally, data can be read from the RFID memory for use by processor 408, for storage in memory 412 and/or transmission via wireless transceiver 414.

Additionally, the RFID reader 404 can serve as a wakeup circuit for the wireless portion of the multimode tag 400. In this embodiment, RFID tag 402 would receive a signal from a remote RFID reader (not pictured). Upon receipt, RFID tag 402 would send a signal to RFID reader 404. In turn, RFID reader 404 will provide a wakeup signal to processor 408.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. An asset tag for use in an WLAN/RFID system, the asset tag comprising:
a processor;
an RFID communication section coupled to the processor and configured to receive interrogations from an RFID reader and send replies to the RFID reader; and
a wireless communication section coupled to the processor and configured to receive information from and send information to a wireless access port of a wireless local area network.

2. The tag of claim 1 further comprising a wakeup circuit configured to place the tag in an operational state from an idle state upon receipt of a signal.

3. The tag of claim 2 wherein the wakeup circuit is configured to receive a signal from a wide area pager circuit.

4. The tag of claim 2 wherein the wakeup circuit is configured to receive a signal from a local area pager circuit.

5. The tag of claim 2 wherein the wakeup circuit is configured to be triggered by an RFID reader transmission.

6. The tag of claim 1 wherein the tag is a passive tag.

7. The tag of claim 1 wherein the tag is a semi-passive tag.

8. The tag of claim 1 further comprising a charging circuit coupled between the processor and a battery.

9. The tag of claim 8 wherein the tag is an active tag.

10. The tag of claim 8 wherein the charging circuit is operable to receive energy generated by an inductive coupling of the tag and an RFID reader to charge the battery.

11. The tag of claim 1 further comprising a non-volatile memory coupled to the processor, the memory configured to be readable and writeable.

12. The tag of claim 11 wherein the non-volatile memory is configured to store data sent by a RFID reader.

13. The tag of claim 11 wherein a wireless transceiver of the wireless communication section is configured to receive data to be written to the memory, the wireless transceiver configured to send the data to the processor when the processor is configured to store the data to the memory.

14. The tag of claim 13 wherein the wireless transceiver is configured to retrieve data from the memory and send it to a wireless network upon request from the wireless network.

15. The tag of claim 1 further comprising a sensor coupled to the processor, the sensor configured to monitor conditions external to the tag, the processor configured to receive data from the sensor and respond to the detection of a predefined event.

16. The tag of claim 15 wherein the sensor is a motion sensor and the predefined event is the detection of movement.

17. The tag of claim 15 wherein the sensor is an acoustic sensor and the predefined event is the detection of a sound pattern or level.

18. The tag of claim 15 wherein the sensor is a thermal sensor and the predefined event is the detection of a predetermined temperature.

19 The tag of claim 15 wherein the sensor is a humidity sensor and the predefined event is the detection of a predetermined humidity level.

20 The tag of claim 1 wherein the tag is configured to emulate an active tag, a passive tag or a semi-passive tag.

21. The tag of claim 20 wherein the emulation of the tag is determined by the charge state of a battery.

22. The tag of claim 20 wherein the emulation of the tag is based on a command sent to a wireless transceiver of the wireless communication section.

23. The tag of claim 20 wherein the emulation of the tag is set to achieve an optimal balance between power efficiency, communication range and data transfer rate.

24. The tag of claim 20 wherein the tag is set to emulate a passive tag when the tag is idle.

25. A system for tracking an asset within a wireless local area network comprising:
a plurality of wireless access points coupled to a one server computer;
a tag attached to the asset, the tag comprising a wireless transceiver configured to send signals and to receive signals from the plurality of wireless access points; and
wherein the server computer is configured to determine the location of the asset based on signals sent from the tag.

26. The system of claim 25 wherein the server is configured to determine the location of the asset by comparing the relative signal strength of a tracking signal sent by the tag and received by a subset of the plurality of wireless nodes.

27. The system of claim 25 wherein the server is configured to determine the location of the asset based on the angle of arrival of a tracking signals sent by the tag and received by a subset of the plurality of wireless access points.

28. The system of claim 25 wherein the server is configured to determine the location of the asset based on the time difference of arrival of a tracking signal sent by the tag and received by a subset of the plurality of wireless access points.

29. The system of claim 25 wherein the tag further comprises a non-volatile memory containing data about the asset the tag is attached to.

30. The system of claim 29 wherein the wireless transceiver is configured to send data stored in the non-volatile memory upon a request transmitted by the wireless transceiver.

31. The system of claim 25 wherein the wireless transceiver is configured to turnoff after a period of inactivity.

32. The system of claim 31 further comprising a paging system coupled to the server, the paging system configured to send a signal to the tag to turn on the wireless transceiver.

33. The system of claim 25 wherein the tag is a passive tag.

34. The system of claim 25 wherein the tag is a semi-passive tag.

35. The system of claim 25 further comprising a charging circuit coupled between the processor and a battery.

36. The system of claim 35 wherein the tag is an active tag.

37 The system of claim 25 wherein the tag is configured to emulate an active tag, a passive tag or a semi-passive tag.

38. The system of claim 37 wherein the emulation of the tag is determined by the charge state of a battery.

39. The system of claim 37 wherein the emulation of the tag is based on a command sent to the wireless transceiver.

40. The system of claim 37 wherein the emulation of the tag is set to achieve an optimal balance between power efficiency, communication range and data transfer rate.

41. The system of claim 37 wherein the tag is set to emulate a passive tag when the tag is idle.

42. An asset tag for use in an WLAN/RFID system, the asset tag comprising:
a battery;
a processor coupled to the battery;
an RFID antenna coupled to the processor and configured to receive interrogations from an RFID reader and send replies to the RFID reader;
a wireless transceiver coupled to the processor, the wireless transceiver configured to receive information from and send information to a wireless access port of a wireless local area network; and
wherein the tag is configured to emulate an active tag, a passive tag or a semi-passive tag.

43. The tag of claim 42 wherein the emulation of the tag is determined by the charge state of the battery.

44. The tag of claim 42 wherein the emulation of the tag is based on a command sent to the wireless transceiver.

45. The tag of claim 42 wherein the emulation of the tag is set to achieve an optimal balance between power efficiency, communication range and data transfer rate.

46. The tag of claim 42 wherein the tag is set to emulate a passive tag when the tag is idle.

47. An asset tag for use in a WLAN/RFID system, the asset tag comprising:
a battery;
a processor coupled to the battery;
an RFID communication section coupled to the processor and configured to receive interrogations from an RFID reader and send replies to the RFID reader; and
wherein the tag is configured to emulate an active tag, a passive tag or a semi-passive tag.

48. The tag of claim 47 further comprising a wireless communication section coupled to the processor, the wireless communication section configured to receive information from and send information to a wireless access port of a wireless local area network.

49. The tag of claim 47 wherein the emulation of the tag is determined by the charge state of the battery.

50. The tag of claim 48 wherein the emulation of the tag is based on a command sent to the wireless communication section.

51. The tag of claim 47 wherein the emulation of the tag is set to achieve an optimal balance between power efficiency, communication range and data transfer rate.

52. The tag of claim 47 wherein the tag is set to emulate a passive tag when the tag is idle.
